(19) United States
(12) Patent Application Publication
(10) Pub. No.: US 2024/0123377 A1
(43) Pub. Date: Apr. 18, 2024

(54) FILTER INSERT FOR INSERTION INTO A FILTER HOUSING

(71) Applicant: HENGST SE, Muenster (DE)

(72) Inventors: Jens BACHMANN, Muenster (DE); Marvin Michael LEE, Muenster (DE); Julian NIEHOFF, Coesfeld (DE); Mark VON LUETZAU, Muenster (DE)

(21) Appl. No.: 18/281,894

(22) PCT Filed: Mar. 7, 2022
(86) PCT No.: PCT/EP2022/055769

§ 371 Date: Sep. 13, 2023

(30) Foreign Application Priority Data
Mar. 16, 2021 (DE) 102021106343.4

(51) Int. Cl. B01D 29/60; B01D 29/21; B01D 36/00

(52) U.S. Cl. CPC B01D 29/605; B01D 29/213; B01D 29/608; B01D 36/005; B01D 2201/56; B01D 2201/64

(57) ABSTRACT

The invention relates to a filter insert for insertion into a filter housing of a fluid filter, comprising a filter material, which is designed to be flowed through by a fluid to be filtered during operation of the fluid filter from a raw side to a pure side of the fluid filter, and to a floatable radio module, which is designed to float on a water quantity located in a water collection area of the fluid filter during operation of the fluid filter.

The invention relates to a filter insert for insertion into a filter housing for a fluid filter, comprising a filter material, which is designed to be flowed through by a fluid to be filtered from a raw side to a pure side of the fluid filter during operation of the fluid filter.

The invention further relates to a fluid filter for filtering a fluid, wherein the fluid filter comprises a filter housing with a radio module on the housing side and a filter insert with a floatable (or buoyant) radio module, wherein the filter insert is designed to be inserted into the filter housing. The floatable radio module and the radio module on the housing side are configured to communicate with each other.

Furthermore, the invention relates to a filter system comprising a fluid filter and an electronic data processing device.

In some fluid filters, it is advantageous or even necessary that water is separated from the fluid to be filtered during filtration. Water separation during fluid filtration is found, for example, in fuel filters or air filters for a fuel cell.

In order to ensure proper operation of the fluid filter, the water separated from the fluid and accumulating in a collection water area of the fluid filter must be drained from the filter housing of the fluid filter or removed in some other way. To monitor the water level, the filter housings for corresponding fluid filters can be equipped with a viewing window through which the level in the water collection area can be visually checked by a person. Furthermore, fluid filters are known that are equipped with a water level sensor, so that monitoring of the filling level in the water collection area can be implemented via the sensor data from the water level sensor.

In a multitude of applications in which fluid filters with water separation are used, there is a need for smart fluid filters that are able to provide information beyond the water level in the water collection area, which, for example, allows for identification of the filter insert used or concerns operating parameters for the fluid filter or the filter insert. This is not yet possible with the sensors used to detect the water level.

In other fluid filters, for example, in a fluid filter for a steam pressure cleaner, water also accumulates in a water collection area.

The task underlying the invention is therefore to enable smart water level detection in a fluid filter, in which information beyond the water level in the water collection area of the fluid filter is provided for operating the fluid filter or operating the machine in which the fluid filter is used.

The task is solved by a filter insert of the type mentioned above, wherein the filter insert according to the invention has a floatable radio module, which is set up to float on a quantity of water located in a water collection area of the fluid filter during operation of the fluid filter.

Because the floatable radio module can float on the amount of water in the water collection area, the position of the floatable radio module changes simultaneously with the water level in the water collection area. The floatable radio module is preferably arranged to move in the axial direction during operation of the fluid filter depending on the water level in the water collection area of the fluid filter. The floatable radio module thus allows radio-based detection of the water level in the water collection area of the fluid filter. The floatable radio module also allows for radio-based identification of the filter insert, as it enables information to be provided that goes beyond a water level indication. Thus, by means of the floatable radio module, for example, filter insert-specific, fluid filter-specific and/or fluid-specific information can be provided, which can be used to operate the fluid filter or to operate the machine in which the fluid filter is used.

The filter material is preferably designed to separate water from the fluid during operation of the fluid filter. The floatable radio module is preferably designed to float on a quantity of water separated from the fluid during operation of the fluid filter.

For example, the fluid filter may be a fuel filter whereby the fluid is fuel. The fluid filter may also be an air filter for a fuel cell. Alternatively, the fluid filter may be part of a steam pressure washer.

The filter material may form a circumferential filter material body. The filter material may be folded several times and/or formed as bellows.

In a preferred embodiment of the filter insert according to the invention, the floatable radio module has a lower density than water and/or a density of less than 997 kg/m³. Due to such a density, the floatable radio module floats on the surface of the water. Thus, it can be achieved that the floatable radio module changes its axial position depending on the current water level in the water collection area.

In a further preferred embodiment of the filter insert according to the invention, the floatable radio module is arranged to float, during operation of the fluid filter, in a boundary layer between the fluid to be filtered on the raw side of the fluid filter and the quantity of water located in the water collection area of the fluid filter. In this case, the floatable radio module has a higher density than the fluid to be filtered.

Furthermore, a filter insert according to the invention is preferred in which the floatable radio module has a higher density than gasoline and/or diesel and/or a density of more than 748 kg/m³ or more than 833 kg/m³. Gasoline has a density of 748 kg/m³. Diesel has a density of 833 kg/m³. In this case, the filter insert is designed to be used in a fuel filter, in particular, in a diesel filter or a gasoline filter. The floatable radio module is preferably designed to float in a boundary layer between the fuel to be filtered on the raw side of the fluid filter and the amount of water present in the water collection area of the fluid filter.

It is further preferred to have a filter insert according to the invention in which the floatable radio module is arranged to communicate with a radio module on the housing side of the fluid filter for detecting the water level in the water collection area of the fluid filter, with the distance from the radio module on the housing side to the floatable radio module changing when the water level in the water collection area of the fluid filter changes. The radio module on the housing side is preferably immovably arranged on the filter housing or immovably integrated into the filter housing. The movement of the floatable radio module is caused by a change in the water level, so that the detection of the water level takes place via the changing distance between the radio module on the housing side and the floatable radio module. In this respect, the floatable radio module allows for radio-based detection of the water level in the water collection area.

The filter insert can also have several floatable radio modules or one floatable radio module with several radio units, which are set up to float on the amount of water located in the water collection area of the fluid filter during operation of the fluid filter for detecting the water level in the water collection area of the fluid filter, and to communicate with a radio module on the housing side of the fluid filter. The plurality of floatable radio modules or the plurality of radio units for the one floatable radio module can be radio modules or radio units of the same type or radio modules or radio units of different types. The plurality of floatable radio modules or the plurality of radio units of the one floatable radio module can use different types of modulation, for example, so that their radio signals are distinguishable. Furthermore, the radio signals can be assigned to a floatable radio module or a radio unit for the one floatable radio module using a transmitted identifier. The plurality of floatable radio modules or the plurality of radio units for the one floatable radio module can use the same transmission frequency or transmission frequencies differing from one another. The number of floatable radio modules communicating with the radio module on the housing side or the number of radio units for the one floatable radio module communicating with the radio module on the housing side is preferably dependent on their axial position and thus on the distance thereof from the radio module on the housing side. Thus, the distance between the radio module on the housing side and the floatable radio modules or the distance between the radio module on the housing side and the radio units for the one floatable radio module can be determined via the number of floatable radio modules communicating with the radio module on the housing side or the number of radio units for the one floatable radio module communicating with the radio module on the housing side, from which the water level in the water collection area can be derived. The plurality of floatable radio modules or the plurality of radio units for the one floatable radio module can be arranged one above the other. At a small distance from the radio module on the housing side, a larger number of floatable radio modules or a larger number of radio units for the one floatable radio module communicates with the radio module on the housing side than at a greater distance from the radio module on the housing side.

The communication between the floatable radio module and the radio module on the housing side can take place continuously or discontinuously. The communication between the floatable radio module and the radio module on the housing side can take place at regular or at irregular intervals and/or can be triggered or prompted by specific events. Thus, the determination of the water level in the water collection area takes place at regular or at irregular intervals and/or in an event-dependent manner.

In a further development of the filter insert according to the invention, the floatable radio module is configured to transmit one or more radio signals by means of which the distance from the floatable radio module to the radio module on the housing side can be determined and/or which allows for identification of the filter insert or a type recognition of the filter insert. For example, the floatable radio module is configured to transmit a one-time allocated and/or filter insert-specific identifier, so that the filter insert located in the filter housing can be identified via a signal evaluation. The one or more radio signals can also be used to transmit filter-operating information, such as the operating performance or the previous operating time, to the radio module on the housing side. Furthermore, fluid-related operating information can be transmitted from the floatable radio module to the radio module on the housing side, for example the current temperature of the water or the fluid to be filtered or a higher temperature development related thereto. The filter insert-related and/or fluid-related operating information can be determined and recorded by the floatable radio module during operation. The floatable radio module can consequently comprise a memory for storing the filter insert-related and/or fluid-related operating information, which is described during operation with the filter insert-related and/or fluid-related operating information.

In a further preferred embodiment, the filter insert according to the invention has a floating chamber in which the floatable radio module is arranged, wherein the floating chamber is designed to protrude into the water collection area of the fluid filter during operation of the fluid filter. The floating chamber can be a floating cage, for example. The floatable radio module can comprise a module housing or a module body, which is arranged in the floating chamber. The module housing or the module body can be made of plastic, for example. The floatable radio module can be formed, for example, by a floatable plastic element with an integrated RFID Tag.

Furthermore, a filter insert according to the invention is advantageous in which the floating chamber has a lift range for the floatable radio module, which allows the floatable radio module to rise when the water level rises in the water collection area of the fluid filter. Within the lift range, the floatable radio module can perform an axial movement when the water level rises.

In another embodiment of the filter insert according to the invention, the floatable radio module or an additional radio module on the filter insert side is configured to move during operation of the fluid filter as a function of the pressure difference between the raw side and the pure side of the fluid filter and to communicate the soiling state of the filter insert with a radio module of the fluid filter on the housing side and the distance thereof to the floatable radio module or to the additional radio module on the filter insert side during movement of the floatable radio module or the additional radio module on the filter insert side. The floatable radio module or the additional radio module on the filter insert side can also allow for radio-based identification of the filter insert. The floatable radio module or the additional radio module on the filter insert side also allows for radio-based detection of the soiling state of the filter material. The floatable radio module or the additional radio module on the filter insert side is preferably configured to move in the axial direction as a function of the pressure difference between the raw side and the pure side of the fluid filter during operation of the fluid filter.

The filter insert can also have a plurality of additional radio modules on the filter insert side, which are designed to move during operation of the fluid filter for detecting the soiling state of the filter material as a function of the pressure difference between the raw side and the pure side of the fluid filter, and to communicate with a radio module for the fluid filter on the housing side. The plurality of radio modules on the filter insert side can be radio modules of the same type or radio modules of different types. The additional radio modules on the filter insert side can use different types of modulation, for example, so that their radio signals are distinguishable. Furthermore, the radio signals can be assigned to one of the additional radio modules on the filter insert side on the basis of a transmitted identifier. The plurality of additional radio modules on the filter insert side can use the same transmission frequency or transmission frequencies that differ from one another. The number of additional radio modules on the filter insert side communicating with the radio module on the housing side is preferably dependent on their axial position and thus on the distance thereof from the radio module on the housing side. Thus, the distance between the radio module on the housing side and the radio modules on the filter insert side can be determined via the number of additional radio modules on the filter insert side communicating with the radio module on the housing side, from which the soiling state of the filter material can be derived. The additional radio modules on the filter insert side can be arranged one above the other. At a small distance from the radio module on the housing side, a larger number of additional radio modules on the filter insert side communicates with the radio module on the housing side than at a greater distance from the radio module on the housing side.

In another preferred embodiment of the filter insert according to the invention, the additional radio module on the filter insert side is configured to transmit one or more radio signals by means of which the distance from the additional radio module on the filter insert side to the radio module on the housing side can be determined and/or which allows for identification of the filter insert or a type recognition of the filter insert. By way of example, the additional radio module on the filter insert side transmits a unique identifier or a filter insert-specific identifier. The filter insert can have a bypass valve or at least part of a bypass valve, wherein the additional radio module on the filter insert side is arranged on the bypass valve or the part of the bypass valve on the filter insert side or is integrated into the bypass valve or the part of the bypass valve on the filter insert side. During operation of the fluid filter, the bypass valve is arranged between the raw side and the pure side of the fluid filter. Preferably, the bypass valve has a movable closure body or the part of the bypass valve on the filter insert side is a movable closure body, which is designed to move relative to a contact body of the bypass valve bearing a valve seat, depending on the pressure difference between the raw side and the pure side of the fluid filter, wherein the additional radio module on the filter insert side is arranged on the closure body of the bypass valve and/or is designed to move together with the closure body for the bypass valve. The closure body preferably ensures a radial seal. The closure body is the part of the bypass valve, which executes the movement leading to an opening of the bypass valve. The contact body bearing the valve seat is the part of the bypass valve that is stationary during the opening of the bypass valve or does not carry out any movement. The closure body is preferably a shut-off piston. The closure body of the bypass valve is preferably configured to move in the axial direction depending on the pressure difference between the raw side and the pure side of the fluid filter during operation of the fluid filter. The closure body is preferably configured to block a bypass line between the raw side and the pure side until the pressure difference between the raw side and the pure side reaches a differential pressure limit value. When the differential pressure limit value is reached, the closure body then releases the bypass line so that at least a portion of the fluid to be filtered can reach the pure side from the raw side without flowing through the filter material. The bypass line can be formed by one or more passage openings in a wall surrounding the closure body, which are released by an axial movement of the closure body. Below the differential pressure limit value or before reaching the differential pressure limit value, the closure body moves with increasing differential pressure, without the bypass line being released. The closure body can be arranged in a guide sleeve, which is designed to guide the closure body during a differential pressure-related movement, wherein the guide sleeve is surrounded by the filter material. Preferably, the bypass valve has a movable contact body or the filter insert-side part of the bypass valve is a movable contact body, which carries a valve seat for a closure body of the bypass valve, wherein the contact body is designed to move relative to the closure body depending on the pressure difference between the raw side and the pure side of the fluid filter, wherein the additional radio module on the filter insert side is arranged on the contact body of the bypass valve and is configured to move together with the contact body of the bypass valve.

The radio module on the filter insert side can also be fastened to elastomer bellows for the filter insert, wherein the elastomer bellows is deformed with increasing differential pressure between the raw side and the pure side of the fluid filter and allows an axial movement of the radio module on the filter insert side.

The filter material is preferably supported by a support structure, which is designed to move together with the filter material during operation of the fluid filter as a function of the pressure difference between the raw side and the pure side of the fluid filter, wherein the additional radio module on the filter insert side is arranged on the support structure or the filter material or is configured to move together with the support structure and/or the filter material. The support structure can be one-piece or multi-piece. The support structure is preferably configured to move in the axial direction together with the filter material as a function of the pressure difference between the raw side and the pure side of the fluid filter during operation of the fluid filter. The radio module on the filter insert side can be arranged centrally on the support structure. The floatable radio module and the radio module on the filter insert side can communicate with the same radio module on the housing side or with different radio modules on the housing side. Preferably, the type of the floatable radio module differs from the type of the additional radio module on the filter insert side, so that a radio module on the housing side communicating with these radio modules can assign the received signals. The floatable radio module and the additional radio module on the filter insert side are preferably configured to use different modulation types and/or transmission frequencies.

In a development of the filter insert according to the invention, the floatable radio module and/or the additional radio module on the filter insert side are each configured to refer to the energy required for communication with the radio module on the housing side from an electromagnetic field generated by the radio module on the housing side. The floatable radio module and/or the additional radio module on the filter insert side therefore do not require their own power supply. In this respect, wiring of the floatable radio module and/or the additional radio module on the filter insert side can be dispensed with. This ensures less wear and increased reliability. Furthermore, restrictions in the arrangement of the floatable radio module and/or the additional radio module on the filter insert side are omitted.

In a development of the filter insert according to the invention, the floatable radio module and/or the additional radio module on the filter insert side each comprises a transponder, in particular, an RFID transponder. Alternatively, the floatable radio module and/or the additional radio module on the filter insert side can each be designed as a transponder, in particular, as an RFID transponder. The radio module on the housing side preferably comprises an RFID reading device or is designed as an RFID reading device.

Furthermore, the floatable radio module and/or the additional radio module on the filter insert side can be configured to detect or measure the electrical conductivity of the fluid in the vicinity of the floatable radio module and/or the radio module on the filter insert side. The electrical conductivity of fluids increases over time due to the ingress of soot and water or metal abrasion, so that the fluid quality can be determined by measuring the electrical conductivity. To measure the electrical conductivity, the floatable radio module and/or the additional radio module on the filter insert side could have an open or interrupted electrical line, the condition of which is monitored by means of an electronic monitoring device. The electrical conductivity of the fluid and thus the current fluid quality are then determined via a current flow and/or resistance measurement on the open line.

In a further preferred embodiment of the filter insert according to the invention, the floatable radio module and/or the additional radio module on the filter insert side has a temperature measuring device and is configured to transmit temperature measurement values to the radio module on the housing side. The filter insert can, for example, be a fuel filter insert. The radio module on the housing receives, for example, a temperature signal from the floatable radio module and/or the additional radio module on the filter insert side. The floatable radio module and/or the additional radio module on the filter insert side can comprise an additional micro-controller and one or more temperature sensors, which form the temperature measuring device. The transmitted temperature measurement values can be used for controlling or regulating a heating device, in particular a fuel heating device. If the fuel temperature is too low, the fuel heating device is switched on. The radio module on the housing side can regulate the fuel heating device. The one or more temperature sensors can each have a temperature-dependent resistor, for example an NTC resistor or a PTC resistor. To detect fuel temperatures, the detection range of such sensors is sufficient, since only comparatively low temperatures below 80° C. have to be detected. Furthermore, it is not necessary to measure this permanently, but only during engine start-up and/or at regular or irregular time intervals.

Moreover, the problem underlying the invention is solved by a fluid filter of the type mentioned above, wherein the filter insert for the fluid filter according to the invention is designed according to one of the embodiments described above. With regard to the advantages and modifications of the fluid filter according to the invention, reference is thus first made to the advantages and modifications of the filter insert according to the invention.

In a preferred embodiment of the fluid filter according to the invention, the radio module on the housing side is configured to receive one or more radio signals from the floatable radio module by means of which the distance from the floatable radio module to the radio module on the housing side is ascertainable. The radio module on the housing side can further be configured to receive one or more radio signals from an additional radio module on the filter insert side, by means of which the distance from the additional radio module on the filter insert side to the radio module on the housing side can be determined. Via the determined distance from the floatable radio module to the radio module on the housing side, the water level in the water collection area of the fluid filter can then be determined via a relationship between the distance and the water level or via a corresponding characteristic map. The soiling state of the filter material for the filter insert can be determined via a relationship between the distance and the soiling state or via a corresponding characteristic map by means of the determined distance from the additional radio module on the filter insert side to the radio module on the housing side.

It is also preferred to have a fluid filter in which the filter housing comprises a housing base body and a housing cover, wherein the radio module on the housing side is arranged in or on the housing base body or on the housing cover. The housing base body and the housing cover can preferably be detachably connected to one another in a non-destructive manner, for example, via corresponding threaded portions on the housing base body and the housing cover. The housing cover can be screwed onto the housing base body, for example. The housing cover may have a cup shape, for example. For example, the water collection area can be arranged in the housing cover. The filter housing for the fluid filter according to the invention can further comprise a supporting mandrel for the filter insert, wherein the radio module on the filter housing side is arranged on the supporting mandrel.

In a preferred embodiment, the fluid filter according to the invention has a water drainage valve for draining the water, which accumulates in a water collection area of the fluid filter, wherein the water drainage valve is designed to be actuated as a function of the distance between the floatable radio module and the radio module on the housing side. In this case, the fluid filter can, for example, be a fuel filter. The water drainage valve can, for example, be opened and/or closed automatically as a function of the water level in the water collection area. For example, when a water fill level limit value is reached or exceeded, the water drainage valve can be opened automatically in order to discharge the water from the water collection area or from the fluid filter. The water fill level can be determined, for example, by a data processing device for a filter system, via the distance between the floatable radio module and the radio module on the housing side. The water drainage valve can be a solenoid valve. The control of the water drainage valve as a function of the distance between the floatable radio module and the radio module on the housing side preferably takes place via a control device, which is part of a filter system. In addition to the floatable radio module, the filter insert for the fluid filter can have a radio module on the filter insert side, which is designed to move during operation of the fluid filter as a function of the pressure difference between the raw side and the pure side of the fluid filter depending on the soiling state of the filter material. However, such a radio module on the filter insert side is not absolutely necessary. The filter insert for the fluid filter can also comprise a floatable radio module for controlling the water drainage without a radio module on the filter insert side for detecting the dirt.

The object underlying the invention is further achieved by a filter system of the type mentioned in the introduction, wherein the fluid filter for the filter system according to the invention is designed according to one of the above-described embodiments and the data processing device is configured to evaluate one or more signals transmitted from the floatable radio module to the radio module on the housing side and/or the signal properties thereof for determining the distance between the floatable radio module and the radio module on the housing side. To detect the distance, the data processing device preferably determines the signal quality of the radio signals received by the radio module on the housing side. For this purpose, the radio module or the data processing device on the housing side can have an amplifier circuit for signal amplification and/or a filter circuit for signal filtering. With regard to the advantages and modifications of the filter system according to the invention, reference is first made to the advantages and modifications of the fluid filter according to the invention.

Furthermore, the data processing device can be configured to evaluate one or more signals transmitted from an additional radio module on the filter insert side to the radio module on the housing side and/or the signal properties thereof for determining the distance between the additional radio module on the filter insert side and the radio module on the housing side in order to determine the soiling state of the filter material on the basis of this evaluation.

In a preferred embodiment of the filter system according to the invention, the electronic data processing device is configured to determine the distance between the floatable radio module and the radio module on the housing side on the basis of the signal strength and/or the signal noise of the one or more radio signals emitted by the floatable radio module. Alternatively or additionally, the electronic data processing device is configured to determine the distance between the additional radio module on the filter insert side and the radio module on the housing side on the basis of the signal strength and/or the signal noise of the one or more radio signals emitted by the additional radio module on the filter insert side. Via the signal strength and the signal noise, the distance between the floatable radio module and the radio module on the housing side or between the additional radio module on the filter insert side and the radio module on the housing side can be calculated comparatively precisely via a corresponding signal evaluation. The water level in the water collection area and the contamination state of the filter material can then be determined on the basis of this calculation.

In a further preferred embodiment of the fluid filter according to the invention, the electronic data processing device is configured to determine the water level in the water collection area of the fluid filter on the basis of the distance between the floatable radio module and the radio module on the housing side. To determine the water level in the water collection area of the fluid filter, the electronic data processing device can use an, in particular, filter-specific, filter insert-specific or filter material-specific relationship between the distance from the floatable radio module on the housing side and the water level in the water collection area of the fluid filter. The relationship can take into account, for example, the filter-specific distance from the floatable radio module to the radio module on the housing side in the case of an empty water collection area and/or the filter-specific distance from the floatable radio module to the radio module on the housing side in the case of a maximum fill level in the water collection area. The electronic data processing can also be configured to determine the soiling state of the filter material on the basis of the distance between an additional radio module on the filter insert side and the radio module on the housing side.

Preferred embodiments of the invention are explained and described in more detail below with reference to the accompanying drawings, in which:

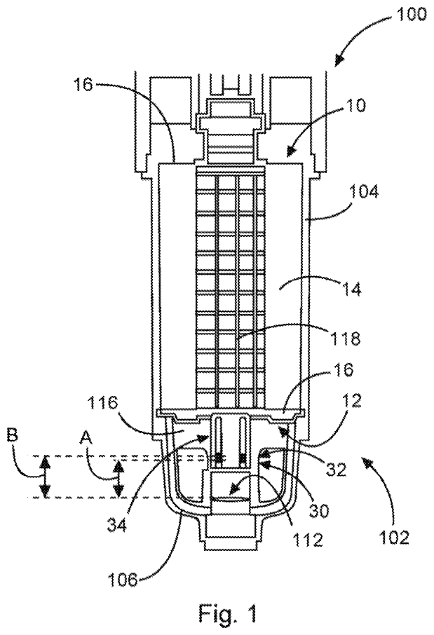

FIG. 1 shows a schematic sectional view of an exemplary embodiment of the fluid filter according to the invention;

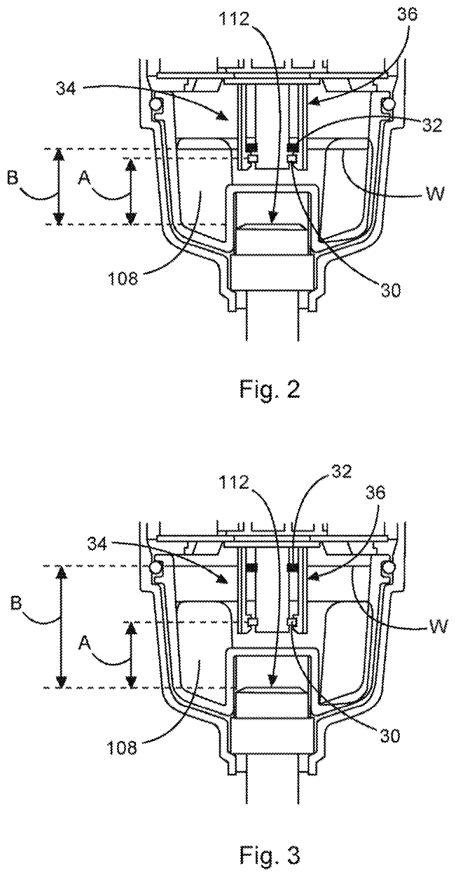

FIG. 2 shows the water collection area of the fluid filter shown in FIG. 1 with a low water level;

FIG. 3 shows the water collection area of the fluid filter shown in FIG. 1 with a high water level;

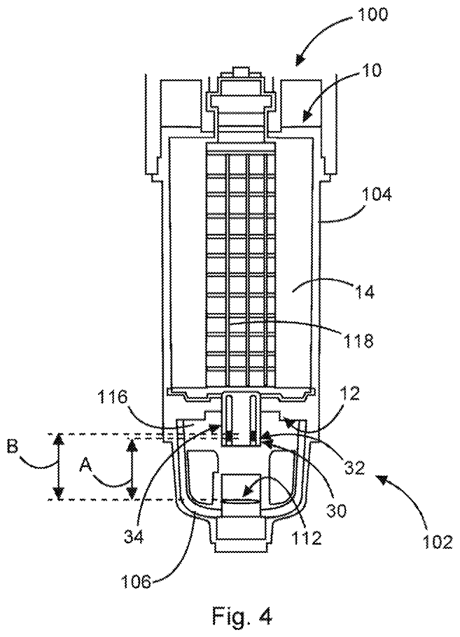

FIG. 4 shows a schematic sectional view of the fluid filter shown in FIG. 1 with a heavily contaminated filter material;

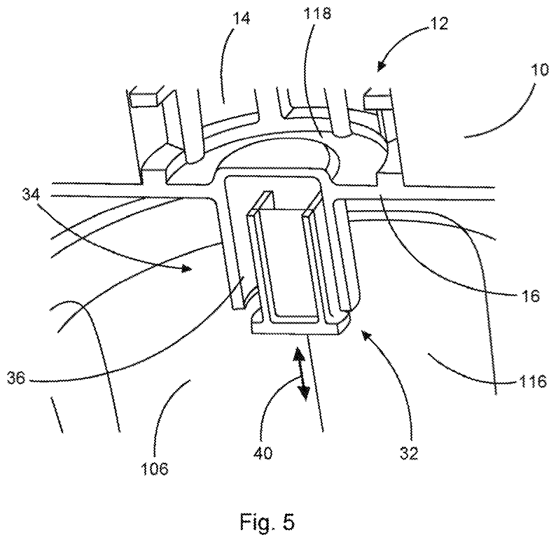

FIG. 5 shows a perspective view of a floatable radio module for a filter insert according to the invention; and

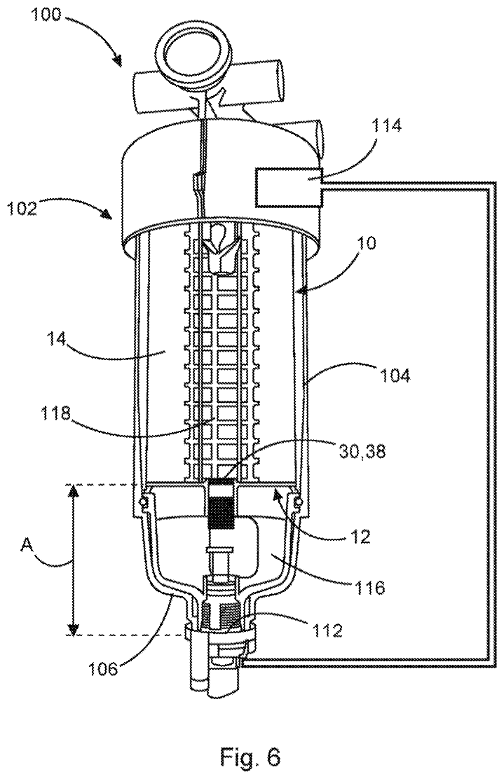

FIG. 6 shows a schematic sectional view of a further embodiment of the fluid filter according to the invention.

FIG. 1 shows a fluid filter 100 designed as a fuel filter. The fluid filter 100 comprises a multi-piece filter housing 102, the filter housing 102 having a housing base body 104 and a housing cover 106.

A filter insert 10 is located in the filter housing 102. The filter insert 10 has circumferential bellows as filter material 14, wherein the fuel to be filtered flows through the filter material 14 during operation of the fluid filter 100 from a raw side 116 to a pure side 118 of the fluid filter 100. The filter material 14 separates water from the fuel during filtration. The separated water accumulates in the water collection area 108 (cf. FIGS. 2 & 3). The filter material 14 is supported by a support structure 12. The support structure 12 comprises end plates 16, which are arranged on the end face of the filter material 14.

The filter insert 10 comprises a floatable radio module 32 and an additional radio module 30 on the filter insert side. The radio modules 30, 32 each comprise an RFID transponder. The floatable radio module 32 is arranged in a floating chamber 36, which is part of a radio module holder 34. The radio module 30 on the filter insert side is fixed to the radio module holder 34 for the filter insert 10.

A radio module 112 on the housing side is arranged on the filter housing 102. The radio module 112 on the housing side comprises an RFID reading device. The radio modules 30, 32 on the filter insert side and the radio module 112 on the housing side are configured to communicate with one another. The radio modules 30, 32 are designed to refer to the energy required for communication with the radio module 112 on the housing side from an electromagnetic field generated by the radio module 112 on the housing side. Thus, the radio modules 30, 32 do not require their own power supply.

FIG. 2 shows that the floating chamber 36 is designed as a floating cage. The floating chamber 36 projects into the water collection area 108 of the fluid filter 100 in which water separated from the fluid to be filtered accumulates during operation of the fluid filter 100. The floatable radio module 32 floats on the water accumulating in the water collection area 108, wherein the floating chamber 36 has a lift range for the floatable radio module 32, which allows the floatable radio module 32 to rise in the water collection area 108 of the fluid filter 100 when the water level W rises. During operation of the fluid filter 100, the floatable radio module 32 floats into a boundary layer between the fuel to be filtered on the raw side of the fluid filter 100 and the water quantity located in the water collection area 108 of the fluid filter 100.

As FIG. 3 shows, the distance B between the floatable radio module 32 and the radio module 112 on the housing side increases with increasing water level W. By evaluating the signal of the radio signals transmitted from the floatable radio module 32 to the radio module 112 on the housing side, an electronic data processing device connected to the radio module 112 on the housing side can determine the distance B. The electronic data processing device evaluates the signals transmitted from the floatable radio module 32 to the radio module 112 on the housing side and/or the signal properties thereof to determine the distance B between the floatable radio module 32 and the radio module 112 on the housing side. Based on the distance B between the floatable radio module 32 and the radio module 112 on the housing side, the electronic data processing device can then determine the water level W in the water collection area 108. The determination of the water level W takes place, for example, via a filter-specific, filter insert-specific or filter material-specific relationship between the distance B from the floatable radio module 32 to the radio module 112 on the housing side and the water level W in the water collection area 108. The relationship takes into account the filter-specific distance B from the floatable radio module 32 and the radio module 112 on the housing side with an empty water collection area 108 and at a maximum fill level in the water collection area 108.

In the exemplary embodiment of the fluid filter 100 shown in FIGS. 1 to 4, the entire filter insert 10 moves in the axial direction between the raw side 116 and the pure side 118 of the fluid filter 100 due to an increase in the differential pressure. The increase in the differential pressure between the raw side 116 and the pure side 118 of the fluid filter 100 results from increasing contamination of the filter material 14. In the condition shown in FIG. 1, the filter material 14 for the filter insert 10 is unsoiled, so that there is a comparatively low differential pressure between the raw side 116 and the pure side 118 of the fluid filter 100. The differential pressure is so small that filter insert 10 rests on an inner edge of housing cover 106. FIG. 4 shows a condition in which the filter material 14 for the filter insert 10 is heavily soiled, so that a comparatively high differential pressure is present between the raw side 116 and the pure side 118 of the fluid filter 100. The high differential pressure between the raw side 116 and the pure side 118 of the fluid filter 100 has led to an axial deflection of the filter insert 10, as a result of which the distance A between the radio module on the filter insert side and the radio module 112 on the housing side was also increased.

The distance A between the radio modules 30, 112 and thus the soiling state of the filter material 14 can be determined by means of a signal evaluation of the radio signals that are transmitted by the radio module 30 on the filter insert side to the radio module 112 on the housing side. The signal evaluation is performed by the electronic data processing device.

The radio module 30 and the radio module 32 are radio modules of different types, which use different types of modulation, so that their radio signals are distinguishable. Furthermore, the radio signals of the radio modules 30, 32 can be assigned to a transmitted identifier.

FIG. 5 also shows a filter insert 10 for a fuel filter 100. During operation, the filter material 14 is flowed through by the fluid to be filtered from a raw side 116 to a pure side 118 of the fluid filter 100, wherein water is separated from the fluid during the filtration. The water separated from the fluid accumulates in the water collection area 108 of the fluid filter 100.

A radio module holder 34, which has a floating chamber 36 protruding into the water collection area 108, is arranged on the end disk 16 of the filter insert 10. A floatable radio module 32 is arranged in the floating chamber 36 and floats on the water quantity located in the water collection area 108 of the fluid filter 100 during operation of the fluid filter. The floating chamber 36 has a lift range for the floatable radio module 32, which allows the floatable radio module 32 to rise in the water collection area 108 of the fluid filter 100 when the water level W rises. Due to the buoyancy range, the floatable radio module 32 can execute an axial movement 40, wherein the axial movement 40 executed by the floatable radio module 32 is dependent on the water level W in the water collection area 108 of the fluid filter 100. The radio module 32 has a module housing made of plastic, into which an RFID tag is integrated.

The floatable radio module 32 communicates with a radio module 112 on the housing side (outside the image section). The radio module 112 on the housing side is configured to receive radio signals from the floatable radio module 32, by means of which the distance B from the floatable radio module 32 to the radio module 112 on the housing side can be determined. To determine the distance B from the floatable radio module 32 to the radio module 112 on the housing side, the radio signals transmitted from the floatable radio module 32 to the radio module 112 on the housing side and/or the signal properties thereof are evaluated by an electronic data processing device. The electronic data processing device determines the distance B between the floatable radio module 32 and the radio module 112 on the housing side on the basis of the signal strength and/or the signal noise of the radio signals transmitted from the floatable radio module 32 to the radio module 112 on the housing side. The electronic data processing device is configured to determine the water level W in the water collection area 108 of the fluid filter 100 on the basis of the distance B between the floatable radio module 32 and the radio module 112 on the housing side. For this purpose, the data processing device can use, for example, a filter-specific, filter insert-specific or filter material-specific relationship between the distance B from the floatable radio module 32 to the radio module 112 on the housing side and the water level W in the water collection area 108 of the fluid filter 100.

FIG. 6 shows a fluid filter 100 designed as a fuel filter, in which the radio module 30 on the filter insert side has a temperature measuring device 38 and is configured to transmit temperature measurement values to the radio module 112 on the housing side. The radio module 30 on the filter insert side can comprise an additional micro-controller and one or more temperature sensors, which form the temperature measuring device 38. The transmitted temperature measurement values can be used for controlling or regulating a heating device 114, wherein the heating device 114 is used for heating the fuel within the filter housing 102. In the case of an excessively low fuel temperature, the heating device 114 can be switched on. The one or more temperature sensors for the temperature measuring device 38 can be thermistors, for example, hot conductors. In the exemplary embodiment shown in FIG. 6, the distance A between the radio module 30 on the filter insert side and the radio module 112 on the housing side and thus the soiling state of the filter material 14 can also be determined via a data processing device.

### LIST OF REFERENCE SIGNS

10 Filter insert
12 Support structure
14 Filter material
16 End disk
30 Radio module
32 Radio module
34 Radio module holder
36 Floating chamber
38 Temperature measuring device
40 Axial movement
10 Fluid filter
102 Filter housing
104 Housing base body
106 Housing cover
108 Water collection area
112 Radio module
114 Heating device
116 Raw side
118 Pure side
A Distance
B Distance
W Water level

1. A filter insert for insertion into a filter housing of a fluid filter, comprising
a filter material, which is designed to be flowed through by a fluid to be filtered during operation of the fluid filter from a raw side to a pure side of the fluid filter;
and a floatable radio module, which is designed to float on a water quantity located in a water collection area of the fluid filter during operation of the fluid filter.

2. The filter insert according to claim 1,
wherein the floatable radio module has a lower density than water and/or a density of less than 997 kg/m³.

3. The filter insert according to claim 1,
wherein the floatable radio module is designed to float in a boundary layer between the fluid to be filtered on the raw side of the fluid filter and the water present in the water collection area of the fluid filter during operation of the fluid filter.

4. The filter insert according to claim 3,
wherein the floatable radio module has a higher density than gasoline and/or diesel and/or a density of more than 748 kg/m³ or more than 833 kg/m³.

5. The filter insert according to claim 1,
wherein the floatable radio module is arranged to communicate with a radio module on the housing side of the fluid filter in order to detect the water level in the water collection area of the fluid filter, the distance of which radio module from the floatable radio module changes in the event of a change in the water level in the water collection area of the fluid filter.

6. The filter insert according to claim 5,
wherein the floatable radio module is configured to transmit one or more radio signals by means of which the distance from the floatable radio module to the radio module on the housing side can be determined and/or which allow for identification of the filter insert or a type recognition of the filter insert.

7. The filter insert according to claim 1,
further comprising a floating chamber in which the floatable radio module is arranged, the floating chamber being designed to protrude into the water collection area of the fluid filter during operation of the fluid filter.

8. The filter insert according to claim 7,
wherein the floating chamber has a lift range for the floatable radio module, which allows the floatable radio module to rise in the water collection area of the fluid filter when the water level rises.

9. The filter insert according to claim 8,
wherein the floatable radio module or an additional radio module on the filter insert side is designed to move during operation of the fluid filter as a function of the pressure difference between the raw side and the pure side of the fluid filter and, in order to detect the soiling state of the filter material, to communicate with a radio module on the housing side of the fluid filter, whereby the distance thereof to the floatable radio module or to the additional radio module on the filter insert side changes when the floatable radio module or the additional radio module on the filter insert side is moved.

10. The filter insert according to claim 9,
wherein the additional radio module on the filter insert side is configured to transmit one or more radio signals by means of which the distance of the additional radio module on the filter insert side to the radio module on the housing side can be determined and/or which allow for identification of the filter insert or a type recognition of the filter insert.

11. The filter insert according to claim 5,
wherein the floatable radio module or the additional radio module on the filter insert side are configured to refer to the energy required for communication with the radio module on the housing side from an electromagnetic field generated by the radio module on the housing side.

12. The filter insert according to claim 1,
wherein the floatable radio module or the additional radio module on the filter insert side comprise a transponder or an RFID transponder, or are designed as transponders or RFID transponders.

13. The filter insert according to claim 5,
wherein the floatable radio module or the additional radio module on the filter insert side have a temperature measuring device (38) and are configured to transmit temperature measured values to the radio module on the housing side.

14. A fluid filter for filtering a fluid, comprising:
a filter housing having a radio module on the housing side, and
a filter insert comprising a floatable radio module, wherein the filter insert is designed to be inserted into the filter housing;
whereby the floatable radio module and the radio module on the housing side are configured to communicate with each other;
wherein at least one filter insert is designed according to claim 1.

15. The fluid filter according to claim 14,
wherein the radio module on the housing side is configured to receive one or more radio signals from the floatable radio module by means of which the distance from the floatable radio module to the radio module on the housing side can be determined.

16. The fluid filter according to claim 15,
wherein
the filter housing has a housing base body and a housing cover, the radio module on the housing side being arranged in the housing base body or the housing cover; or
the filter housing has a supporting mandrel for the filter insert, whereby the radio module on the housing side is arranged on the supporting mandrel.

17. The fluid filter according to claim 14,
further comprising a water drainage valve for draining the water, which accumulates in a water collection area of the fluid filter, wherein the water drainage valve is designed to be actuated depending on the distance between the floatable radio module and the radio module on the housing side.

18. A filter system, comprising
the fluid filter of claim 14, and
an electronic data processing device,
wherein the fluid filter is designed and the data processing device is configured to evaluate one or more signals transmitted from the floatable radio module to the radio module on the housing side or the signal properties thereof to determine the distance between the floatable radio module and the radio module on the housing side.

19. The filter system according to claim 18,
wherein the electronic data processing device is configured to determine the distance between the floatable radio module and the radio module on the housing side on the basis of the signal strength and/or the signal noise of the one or more signals.

20. The filter system according to claim 18,
wherein the electronic data processing device is configured to determine the water level in the water collection area of the fluid filter on the basis of the distance between the floatable radio module and the radio module on the housing side.
